(19) United States
(12) Patent Application Publication
(10) Pub. No.: US 2013/0212416 A1
(43) Pub. Date: Aug. 15, 2013

(54) MOTION ON COMPUTER

(71) Applicant: ADRIAN CRISAN, San Diego, CA (US)

(72) Inventor: ADRIAN CRISAN, San Diego, CA (US)

(73) Assignee: SONY CORPORATION

(21) Appl. No.: 13/370,687

(22) Filed: Feb. 10, 2012

(51) Int. Cl. G06F 1/32

(52) U.S. Cl. 713/323

(57) ABSTRACT

The processor of a computer in the form or a slate or clamshell can reconfigure a computer from a full power wake mode to a low power sleep mode or vice versa by using any combination of criteria that includes input and motion within a threshold period as detected by motion sensors such as a gyroscope, a shock sensor, and an accelerometer.

### FIELD OF THE INVENTION

The present application relates generally to computers that use motion sensors to enter and exit lower power modes and full power modes.

### BACKGROUND OF THE INVENTION

A recent wave of ultra-lightweight clamshell and slate computers has enabled users to use computers in a range of circumstances, including during periods of walking, standing, or sitting in tight public spaces or while relaxing at home. Since these computers typically are battery-powered they are programmed to go into sleep modes to save power. As understood herein, to “wake” the computer to assume a full power, full capability mode, the user must typically locate a switch or other manipulable element and operate it.

### SUMMARY OF THE INVENTION

As understood herein, ultra-lightweight clamshell and slate computer users are constantly changing the orientation of their computers through changing their body positions or by setting down or picking up their computers. As further recognized by present principles, each instance of setting down or picking up an ultra-lightweight clamshell or slate computer can be used to conveniently and automatically change the configuration of the power mode in order to most efficiently utilize battery power. For example, a user may elect to switch from wake mode to sleep mode when they set down a slate computer after using it while in an upright, standing position.

Accordingly, a computer includes a housing and a processor in the housing. The computer can be a clamshell computer or a slate computer. A display can be mounted on the housing and may be controlled by the processor, and a motion sensor can be associated with the housing and may provide signals to the processor representing motion of the housing.

Also, a computer readable medium may be accessible to the processor and may bear instructions executable by the processor to automatically reconfigure the computer from a wake mode, in which at least the display is energized, to a sleep mode, in which at least the display is deenergized. The processor can automatically reconfigure the computer from the wake mode to the sleep mode in response to a determination that the housing has not moved for a period at least equal to the first threshold period

In some embodiments the processor may alternatively reconfigure the computer from the wake mode to the sleep mode in response to a determination that processor has not received user input for a period at least equal to a second threshold period. In either case, the processor may not otherwise automatically reconfigure the computer from the wake mode to the sleep mode. The first threshold period may or may not be equal to the second threshold period.

In another embodiment, a computer can include a housing, a processor in the housing, a display on the housing controlled by the processor, and a motion sensor associated with the housing and providing signals to the processor representing motion of the housing. The computer can be a clamshell computer or a slate computer and may include a computer readable medium that may be accessible to the processor and may bear instructions executable by the processor to automatically reconfigure the computer from a wake mode, in which at least the display is energized, to a sleep mode, in which at least the display is deenergized. The processor may be responsive to a determination that the housing is in a horizontal orientation and that downward motion of the housing has stopped suddenly. The instructions executable by the processor can cause the processor to automatically reconfigure the computer from the wake mode to the sleep mode responsive to a determination that the housing has not moved for a period at least equal to a first threshold period.

In another embodiment of a computer, which can be in the form of a clamshell or a slate, may include a computer that may in turn include a housing, a processor in the housing, a display on the housing controlled by the processor, and a motion sensor associated with the housing and providing signals to the processor representing motion of the housing. A computer readable medium may be accessible to the processor and may bear instructions executable by the processor to automatically reconfigure the computer from a sleep mode, in which at least the display is deenergized, to a wake mode, in which at least the display is energized, responsive to a determination that the housing is in motion. The motion sensor may be a first motion sensor and the computer can include a second motion sensor, which may include a gyro sensor. The processor may automatically reconfigure the computer from the sleep mode to the wake mode only responsive to a determination that signals from both first and second sensors indicate that the housing is in motion. The first sensor can include an accelerometer that may indicate that the housing has been lifted and the second sensor can include an orientation sensor that may indicate that he housing has been turned. The processor can automatically reconfigure the computer from the wake mode to the sleep mode only in response to a determination that the housing has not moved for a period at least equal to the first threshold period and in response to a determination that processor has not received user input for a period at least equal to a second threshold period. In either case, the processor may not otherwise automatically reconfigure the computer from the wake mode to the sleep mode. The first threshold period may or may not be equal to the second threshold period.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an example computer according to present principles in a slate-type configuration;

FIG. 2 is a perspective view of an example computer according to present principles in a clamshell-type configuration;

FIG. 3 is a block diagram of a non-limiting example computer in accordance with present principles;

FIG. 4 is a flow chart of example logic of a first embodiment for entering the low power (sleep) mode;

FIG. 5 is a flow chart of example logic of a second embodiment for entering the low power (sleep) mode;

FIG. 6 is a flow chart of example logic of a first embodiment for entering the high power (wake) mode;

FIG. 7 is a flow chart of example logic of a second embodiment for entering the high power (wake) mode; and

FIG. 8 is a flow chart of example logic of a third embodiment for entering the low power (sleep) mode.

### DETAILED DESCRIPTION OF THE PREFERRED EMBODIMENT

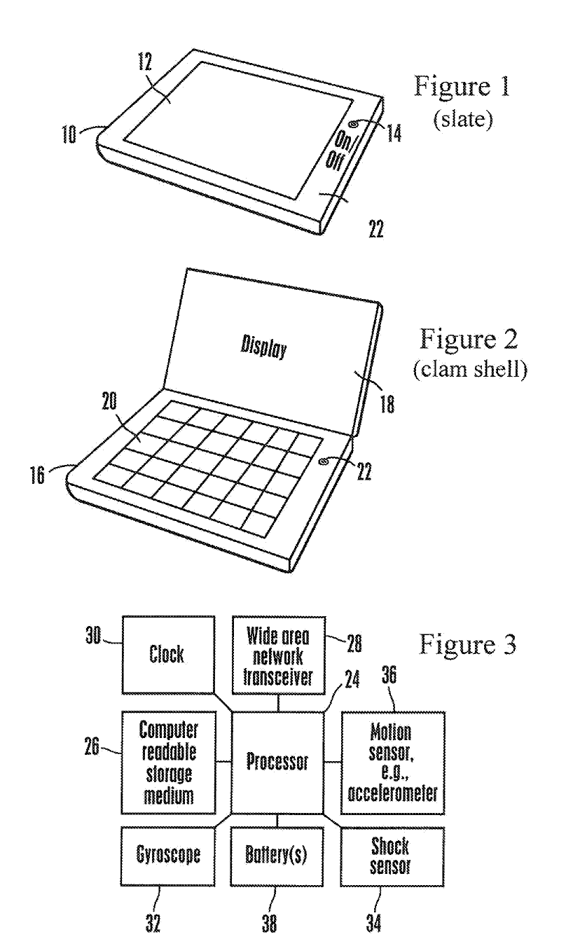

To illustrate example computer types in which present principles may be implemented, FIG. 1 shows a slate-type computer 10 with a display 12 on which may be presented a virtual keyboard and other touchscreen-style input devices. The slate-type computer 10 typically has an on/off switch 14 to turn the computer 10 on and off including reconfiguring the computer from a high power mode, also referred to as a wake mode, to a low power mode, also referred to as a sleep mode. Present principles allow for such transitions without requiring manipulation of the on/off switch 14.

FIG. 2 shows a clamshell-type computer 16 which can also implement present principles. The clamshell-type computer 16 may be a laptop or notebook computer that has a display 18 pivotably engaged with a keyboard 20. An on/off switch 22 is also typically provided on the computer 16.

FIG. 3 illustrates example non-limiting internal components that may be included in the computer 10 of FIG. 1 or the computer 16 of FIG. 2 or other computer according to present principles. As shown, a processor 24 accesses a computer readable storage medium 26 such as disk-based or solid state storage. Note that the computer readable storage medium 26 is not a pure electromagnetic wave per se. The processor 24 can communicate with a wide area network such as the Internet and/or wireless telephony network using a built-in wired or wireless transceiver 28, with the processor 24 executing a software-implemented browser. The transceiver 28 may be, without limitation, a WiFi transceiver, a telephony transceiver such as a global system for mobile communication (GSM) transceiver or code division multiple access (CDMA) transceiver or orthogonal frequency division multiplexing (OFDM) transceiver or combinations or variants thereof. The processor 24 controls a computer display such as one of the displays 12, 18 shown in FIGS. 1 and 2 and receives user commands from an input device such as the touchscreen 12 of FIG. 1 or keyboard 20 of FIG. 2.

Also, as shown in FIG. 3 the processor 24 receives time information from a computer clock 30. According to present principles, the processor 24 receives motion signals from one or more motion sensors in the computer. The motion signals indicate motion and/or orientation of the computer. In the example shown, the processor 24 receives signals from a gyroscope 32 indicating orientation of the computer. Also, the example embodiment shown in FIG. 3 envisions that the processor 24 receives signals from a shock sensor 34 and from an accelerometer 36. The components shown in FIG. 3, as well as the displays shown in FIGS. 1 and 2, can be powered by one or more batteries 38. While FIGS. 1-3 show relevant portions of a slate computer and/or a clamshell computer, present principles apply to smart phones, game consoles, personal digital organizers, etc.

Typically, in a high power mode the display 12/18 is fully energized, as are the components shown in FIG. 3. The processor 24 may have multiple energization modes and in the high power mode is energized at a high energization mode. On the other hand, in the lower power (sleep) mode the display 12/18 typically is deenergized or otherwise in a lower power state, e.g., displaying only a low-power screen saver image. Other components in FIG. 3 are also either deenergized or in a low power mode. For example, the transceiver 28 typically is deenergized in the low power mode, while the processor 24 remains powered on albeit in a lower power mode if so configured to have one.

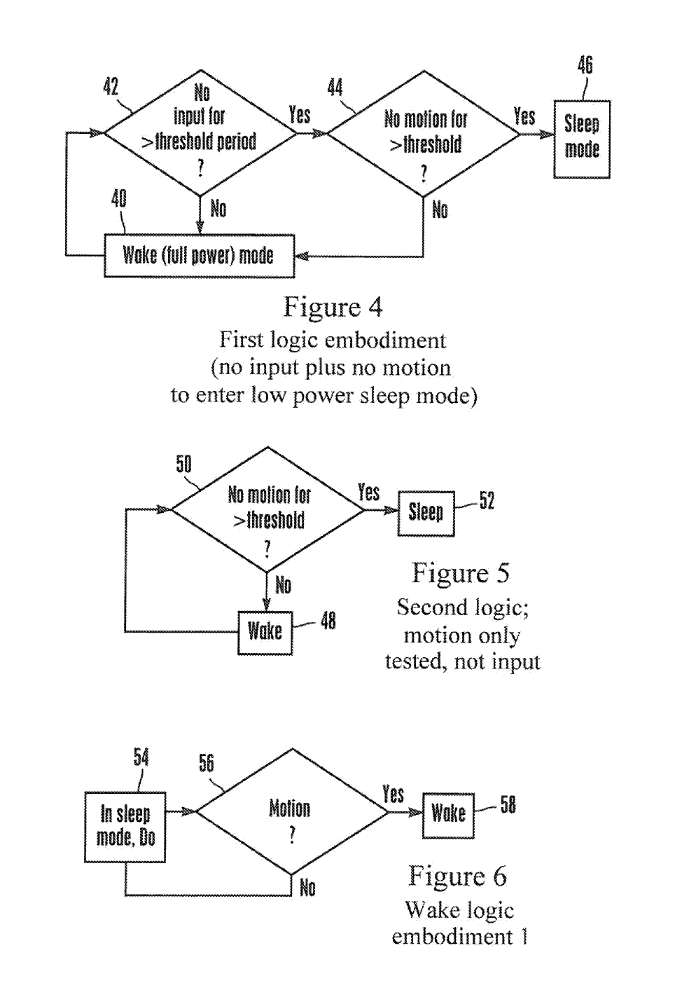

Moving in reference to the logic diagrams, FIG. 4 illustrates a first logic embodiment in which two criteria are met in order for the processor 24 to execute instructions stored on the computer readable medium 26 to reconfigure the computer 10/16 from wake mode to low power sleep mode. Logic begins at block 40, at which point the computer 10/16 is configured in the wake, or full power, mode, and moves to decision diamond 42, at which point the processor 24 determines whether no input has been made for a first threshold period. If input has been made within the first threshold period, the computer 10/16 remains in the wake mode and logic cycles back to block 40. Alternatively, if no input has been made for the first threshold period, logic continues to decision diamond 44.

At decision diamond 44, a second criterion of no motion for a second threshold period is met in order for the processor 24 to reconfigure the computer 10/16 from wake mode to sleep mode. This second threshold period may or may not be equal to the first threshold period. In the case that motion has been detected by any motion sensor 32/34/36 within the second threshold period, the computer 10/16 will remain in wake mode and logic cycles back to block 40. Any number and combination of motion sensors 32/34/36 may be used to communicate to the processor 24. But, if no motion is detected within the second threshold period, then the processor 24 will reconfigure the computer 10/16 from wake mode to sleep mode at block 46.

A second flow of logic in FIG. 5 begins at block 48, at which point the computer 10/16 is configured in wake mode. The meeting of the sole criterion of motion detection within a threshold period is determined at decision diamond 50 by the motion sensors 32/34/36. Any number and combination of motion sensors 32/34/36 may be used to communicate to the processor 24. If motion has been detected within the threshold period, logic reverts back to block 48. If no motion has been detected within the threshold period, logic continues to block 52, at which point the processor 24 reconfigures the computer 10/16 from wake mode to sleep mode.

FIG. 6 begins at block 54 when the computer 10/16 is in sleep mode. The processor 24 continues logic to decision diamond 56 and determines whether motion has been detected by motion sensors 32/34/36 within a threshold period. A determination of no motion by the processor 24 causes logic to revert back to block 54 and the computer 10/16 remains in sleep mode. Alternatively, a determination that motion has been detected by motion sensors 32/34/36 causes the processor 24 to reconfigure the computer 10/16 from sleep mode to wake mode at block 58.

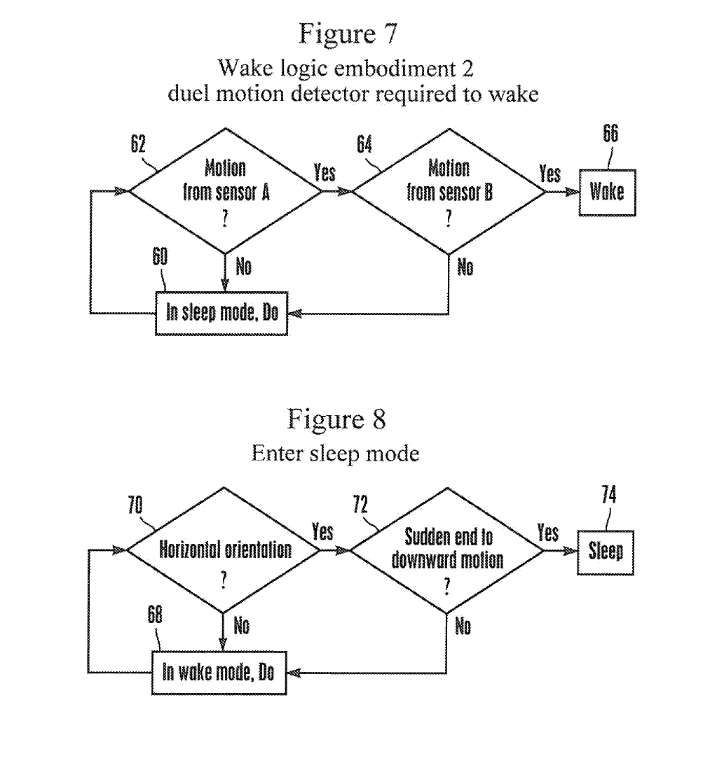

FIG. 7 illustrates a second embodiment of the wake logic where plural motion detectors are used in order to determine whether motion by the computer 10/16 has been made. The computer 10/16 is in sleep mode at block 60. The processor 24 determines whether motion has been detected by a first motion sensor A at decision diamond 62. If motion is detected by motion sensor A, logic moves to decision diamond 64 and the processor 24 determined whether motion has been detected by a second motion sensor B. Examples of motion sensors A and B may include, but are not limited to: a gyroscope 32, a shock sensor 34, and an accelerometer 36.

If the processor 24 detects no motion from either sensor A or sensor B, logic reverts to block 60 and the computer 10/16 remains in sleep mode. Detection of motion by sensor B at decision diamond 64 subsequent to the detection of motion by sensor A at decision diamond 62 causes the processor 24 to reconfigure the computer 10/16 from wake mode to sleep mode at block 66.

FIG. 8 illustrates logic leading to the reconfiguration of the computer 10/16 from wake mode to sleep mode and the logic in this embodiment is based on orientation and downward motion. Block 68 begins the flow of logic with the computer 10/16 in wake mode. The processor 24 determines whether the computer 10/16 is oriented horizontally at decision diamond 70. The processor 24 may receive orientation information from a gyroscope 32.

Determination of horizontal orientation causes the processor 24 to further determine whether a sudden end to downward motion has been achieved at decision diamond 72. The processor 24 may receive downward motion information from one or multiple sensors, including shock sensor 34 and an accelerometer 36.

The determination by the processor 24 of a lack of horizontal orientation or an absence of downward motion causes logic to cycle back to block 68 and the computer 10/16 remains in wake mode. Alternatively, determination by the processor 24 of a sudden end to downward motion at decision diamond 72 subsequent to a determination by the processor 24 of horizontal orientation at decision diamond 70 causes the processor 24 to reconfigure the computer 10/16 from wake mode to sleep mode at block 74.

While the particular MOTION ON COMPUTER is herein shown and described in detail, it is to be understood that the subject matter which is encompassed by the present invention is limited only by the claims.

What is claimed is:

1. Computer comprising:
housing;
processor in the housing;
display on the housing controlled by the processor;
motion sensor associated with the housing and providing signals to the processor representing motion of the housing; and
computer readable medium accessible to the processor and bearing instructions executable by the processor to automatically reconfigure the computer from a wake mode, in which at least the display is energized, to a sleep mode, in which at least the display is deenergized, responsive to a determination that the housing has not moved for a period at least equal to a first threshold period.

2. The computer of claim 1, wherein the processor automatically reconfigures the computer from the wake mode to the sleep mode only responsive to a determination that the housing has not moved for a period at least equal to the first threshold period and responsive to a determination that processor has not received user input for a period at least equal to a second threshold period, and otherwise does not automatically reconfigure the computer from the wake mode to the sleep mode.

3. The computer of claim 2, wherein the first threshold period is equal to the second threshold period.

4. The computer of claim 2, wherein the first threshold period is not equal to the second threshold period.

5. The computer of claim 1, wherein the computer is a slate computer.

6. The computer of claim 1, wherein the computer is a clamshell computer.

7. Computer comprising:
housing;
processor in the housing;
display on the housing controlled by the processor;
motion sensor associated with the housing and providing signals to the processor representing motion of the housing; and
computer readable medium accessible to the processor and bearing instructions executable by the processor to automatically reconfigure the computer from a wake mode, in which at least the display is energized, to a sleep mode, in which at least the display is deenergized, responsive to a determination that the housing is in a horizontal orientation and that downward motion of the housing has stopped suddenly.

8. The computer of claim 7, wherein the instructions executable by the processor cause the processor to automatically reconfigure the computer from the wake mode to the sleep mode responsive to a determination that the housing has not moved for a period at least equal to a first threshold period.

9. The computer of claim 7, wherein the computer is a slate computer.

10. The computer of claim 7, wherein the computer is a clamshell computer.

11. Computer comprising:
housing;
processor in the housing;
display on the housing controlled by the processor;
motion sensor associated with the housing and providing signals to the processor representing motion of the housing; and
computer readable medium accessible to the processor and bearing instructions executable by the processor to automatically reconfigure the computer from a sleep mode, in which at least the display is deenergized, to a wake mode, in which at least the display is energized, responsive to a determination that the housing is in motion.

12. The computer of claim 11, wherein the motion sensor is a first motion sensor and the computer comprises a second motion sensor, and the processor automatically reconfigures the computer from the sleep mode to the wake mode only responsive to a determination that signals from both first and second sensors indicate that the housing is in motion.

13. The computer of claim 12, wherein the first sensor includes an accelerometer indicating that the housing has been lifted and the second sensor includes an orientation sensor indicating that he housing has been turned.

14. The computer of claim 13, wherein the second sensor includes a gyro sensor.

15. The computer of claim 11, wherein the computer is a slate computer.

16. The computer of claim 11, wherein the computer is a clamshell computer.

17. The computer of claim 11, wherein the instructions executable by the processor cause the processor to automatically reconfigure the computer from the sleep mode to the wake mode responsive to a determination that the housing has not moved for a period at least equal to a first threshold period.

18. The computer of claim 17, wherein the processor automatically reconfigures the computer from the wake mode to the sleep mode only responsive to a determination that the housing has not moved for a period at least equal to the first threshold period and responsive to a determination that processor has not received user input for a period at least equal to a second threshold period, and otherwise does not automatically reconfigure the computer from the wake mode to the sleep mode.

19. The computer of claim 18, wherein the first threshold period is equal to the second threshold period.

20. The computer of claim 18, wherein the first threshold period is not equal to the second threshold period.
